(19) United States
(12) Patent Application Publication
(10) Pub. No.: US 2026/0074456 A1
(43) Pub. Date: Mar. 12, 2026

(54) FEMALE TERMINAL, CONNECTOR, TERMINAL-ATTACHED ELECTRIC WIRE, CONNECTOR-ATTACHED ELECTRIC WIRE, AND WIRE HARNESS

(71) Applicants: FURUKAWA ELECTRIC CO., LTD., Tokyo (JP); FURUKAWA AUTOMOTIVE SYSTEMS INC., Inukami-gun (JP)

(72) Inventors: Takuto WADA, Tokyo (JP); Takeshi WATANABE, Inukami-gun (JP); Tomoaki TANIGAWA, Inukami-gun (JP); Sota KAMON, Inukami-gun (JP); Saburo YAGI, Tokyo (JP); Kosuke KATO, Inukami-gun (JP)

(73) Assignees: FURUKAWA ELECTRIC CO., LTD., Tokyo (JP); FURUKAWA AUTOMOTIVE SYSTEMS INC., Inukami-gun (JP)

(21) Appl. No.: 19/389,739

(22) Filed: Nov. 14, 2025

Related U.S. Application Data
(63) Continuation of application No. PCT/JP2024/015513, filed on Apr. 19, 2024.

(30) Foreign Application Priority Data
May 19, 2023 (JP) 2023-082680

(51) Int. Cl. H01R 13/24; H01R 13/11; H01R 13/58

(52) U.S. Cl. CPC H01R 13/2407; H01R 13/113; H01R 13/582

(57) ABSTRACT

In a female terminal 21, a plurality of arm springs 31 contacting a male terminal 11 inserted into an insertion space S are located to be in parallel with a depth direction D, in which the male terminal 11 is inserted into the insertion space S. The plurality of arm springs 31 are arranged in a height direction H perpendicular to a width direction W, in which side walls 213 face each other, and to the depth direction D, and also arranged in the depth direction D. The arm springs 31 are each provided with a contact point 34 protruding to so as to contact the male terminal 11, and the contact points 34 on the plurality of arm springs 31 arranged in the depth direction D are located as being shifted from each other in the height direction H.

### TECHNICAL FIELD

The present invention relates to a connector that is, for example, connected to a connector attached to a casing accommodating an electric device such as, for example, electric equipment mounted on an automobile such as a motor or the like or a power source device such as a battery or the like and is provided in an electric circuit leading to the electric device, a female terminal attached to the connector, a terminal-attached electric wire, a connector-attached electric wire, and a wire harness.

### BACKGROUND ART

Electric equipment mounted on an automobile or the like is connected to an electric device such as another electric equipment, a power supply device or the like via a wire harness including a bundle of covered electric wires. The wire harness and the electric device are connected to each other via connectors attached thereto.

For example, a connector on the side of a harness (hereinafter, referred to as a “harness-side connector”) as described in Patent Literature 1 is connected to a connector on the side of a device included in a casing of a device such as a motor or the like (hereinafter, such a connector will be referred to as a “device-side connector”).

Specifically, the harness-side connector is put into engagement with the device-side connector included in the device such as a motor or the like, and thus a connection terminal provided in the harness-side connector (hereinafter, referred to as a “female terminal”) and a connection terminal provided in the device-side connector (hereinafter, referred to as a “male terminal”) are connected to each other. In this manner, the harness-side connector and the device-side connector are connected to each other in an electrically conductive manner.

This will be described in more detail. In the case where the harness-side connector and the device-side connector are put into engagement with each other, the male terminal, which is plate-like and protrudes inside the device-side connector, is put into engagement with a terminal connection portion of the female terminal located inside the harness-side connector. Thus, the male terminal and the female terminal are connected to each in other an electrically conductive manner.

The terminal connection portion of the female terminal located in the harness-side connector includes a pair of side walls facing each other in a direction crossing a direction in which the harness-side connector and the device-side connector are in engagement with each other, and the plate-like male terminal is inserted into an insertion space between the side walls.

Provided on inner surfaces of the pair of side walls of the female terminal is a spring plate member including a plurality of arm springs that are urged to contact the inserted plate-like male terminal.

Therefore, the plate-like male terminal inserted into the insertion space of the female terminal is electrically connected to the female terminal via the spring plate member including the plurality of arm springs that are urged to contact the plate-like male terminal. The arm springs each have a contact point, provided at a tip thereof, protruding toward the plate-like male terminal in order to allow the arm spring to contact the plate-like male terminal with certainty. Based on whether or not the contact point is at a predetermined position, the state of attachment of the spring plate member to the female terminal is managed.

The wire harness and the electric device are connected to each other at a progressively higher voltage or a progressively higher current. Therefore, regarding the connection of the female terminal and the plate-like male terminal via the spring plate member, the number of the arm springs is increased to increase the number of the contact points. However, when the number of the arm springs, which are lined up in parallel with each other, is increased in the direction in which the arm springs are lined up along such a parallel direction, there occurs a problem that the female terminal and the plate-like male terminal are enlarged in the parallel direction. Therefore, it is conceivable that a plurality of the arm springs are lined up along an insertion direction in which the plate-like male terminal is inserted into the insertion space of the female terminal.

In the case where the plurality of arm springs are lined up along the insertion direction in this manner, the number of the contact points may be increased without the female terminal or the plate-like male terminal being enlarged in the parallel direction. However, when such a plurality of arm springs are lined up along the insertion direction, the positions of the contact points at the tips of the arm springs on a back side in the insertion direction match the positions of the contact points at the tips of the arm springs on a front side in the insertion direction. This makes it difficult to check the positions of the contact points at the tips of the arm springs on the back side in the insertion direction. Therefore, it is difficult to check the positions of the contact points to manage the state of attachment of the spring plate member to the female terminal.

### CITATION LIST

### Patent Literature

Patent Literature 1: JP 2023-018355 A

### SUMMARY OF INVENTION

### Technical Problem

The present invention has an object of providing a female terminal allowing the state of attachment of a spring plate member, including a plurality of arm springs arranged in an insertion direction, to the female terminal to be managed by positions of contact points on the arm springs being checked, a connector, a termina-attached electric wire, a connector-attached electric wire, and a wire harness.

### Solution to Problem

The present invention is directed to a female terminal including a terminal main body connected to an electric wire and a spring member attached to the terminal main body. The terminal main body includes a pair of side walls located apart from each other by a predetermined distance and forming an insertion space into which a male terminal is insertable. The spring member includes a plurality of arm springs contacting the male terminal inserted into the insertion space. The arm springs are arranged to extend in parallel with an insertion direction, in which the male terminal is inserted into the insertion space, and a plurality of the arm springs are lined up along the insertion direction and a plurality of the arm springs are lined up along a perpendicular direction that is perpendicular to a facing direction, in which the side walls face each other, and also perpendicular to the insertion direction. The arm springs are each provided with a contact point protruding so as to contact the male terminal. The contact points on the plurality of arm springs that are lined up along the insertion direction are shifted from each other in the perpendicular direction.

The expression “the contact points on the plurality of arm springs that are lined up along the insertion direction are shifted from each other in the perpendicular direction” refers to that the contact points on the plurality of arm springs lined up along the insertion direction are shifted from each other; and in other words, refers to that the contact points on the plurality of arm springs lined up along the insertion direction are located at different positions from each other in the perpendicular direction.

The present invention is also directed to a connector including the female terminal described above, and a connector housing accommodating the female terminal; and is also directed to a terminal-attached electric wire including the above-described female terminal, and the electric wire connected to the terminal main body of the female terminal.

The present invention is further directed to a connector-attached electric wire including the above-described terminal-attached electric wire, and a connector housing accommodating the terminal-attached electric wire; and is also directed to a wire harness including the above-described terminal-attached electric wire, or a wire harness including the above-described connector-attached electric wire.

According to the present invention, the state of attachment of the spring member, including the plurality of arm springs arranged in the insertion direction, to the female terminal may be checked and managed by the positions of the contact points being checked.

This will be described in more detail. The terminal main body includes the pair of side walls located apart from each other by a predetermined distance and forming the insertion space, into which the male terminal is insertable, and is connected to the electric wire. The spring member attached to the terminal main body includes the plurality of arm springs contacting the male terminal inserted into the insertion space. The arm springs are arranged to extend in parallel with the insertion direction, in which the male terminal is inserted into the insertion space, and a plurality of the arm springs are lined up along the insertion direction and a plurality of the arm springs are lined up in the perpendicular direction perpendicular to the facing direction, in which the side walls face each other, and also perpendicular to the insertion direction.

The arm springs are provided with the contact points protruding so as to contact the male terminal, and the contact points on the plurality of arm springs lined up along the insertion direction are shifted from each other in the perpendicular direction. Therefore, the contact points shifted from each other in the perpendicular direction while being provided on the plurality of arm springs lined up along the insertion direction may be checked from the insertion direction. Therefore, the positions of the contact points on the arm springs on the front side in the insertion direction, and also the positions of the contact points on the arm springs on the back side in the insertion direction, may be checked, and thus the state of attachment of the spring member to the female terminal may be managed.

In an embodiment of the present invention, the contact points provided on the plurality of arm springs that are lined up along the insertion direction may be shifted from each other in the perpendicular direction. The plurality of arm springs that are lined up along the insertion direction may be shifted from each other in the perpendicular direction. Furthermore, the plurality of arm springs lined up along the insertion direction may be shifted from each other in the perpendicular direction, and the contact points provided on the arm springs may be shifted from each other in the perpendicular direction.

In other words, in an embodiment of the present invention, the contact points provided on the plurality of arm springs lined up along the insertion direction may be located at different positions from each other in the perpendicular direction. The plurality of arm springs lined up along the insertion direction may be located at different positions from each other in the perpendicular direction. Furthermore, the plurality of arm springs lined up along the insertion direction may be located at different positions from each other in the perpendicular direction, and the contact points provided on the arm springs may be located at different positions from each other in the perpendicular direction.

According to the present invention, the contact points on the plurality of arm springs lined up along the insertion direction may be shifted from each other in the perpendicular direction with certainty.

In an embodiment of the present invention, the arm springs may be located in two rows lined up along the insertion direction, one of the two rows of the arm springs may protrude in the facing direction when following it from a base side toward a tip side in the insertion direction, and the other of the two rows of the arm springs may protrude in the facing direction when following it from the tip side toward the base side in the insertion direction.

According to the present invention, the contact points provided at the tips of the arm springs become closer to each other in the insertion direction. Therefore, the state of attachment of the spring member to the female terminal may be easily managed.

In an embodiment of the present invention, the arm springs may be located in two rows lined up along the insertion direction, and the two rows of the arm springs may protrude in the facing direction when following them from a base side toward a tip side in the insertion direction.

According to the present invention, the arm springs are inclined in the insertion direction. Thus, the number of the contact points may be increased without the insertion of the male terminal into the insertion space being disturbed.

### Advantageous Effects of Invention

The present invention provides a female terminal allowing the state of attachment of a spring plate member, including a plurality of arm springs arranged in an insertion direction, to the female terminal to be managed by positions of contact points on the arm springs being checked, a connector, a termina-attached electric wire, a connector-attached electric wire, and a wire harness.

### BRIEF DESCRIPTION OF DRAWINGS

FIG. 1 illustrates a connector connection structure.

FIG. 2 is a perspective view of the connector connection structure in a divided state.

FIG. 3 is a perspective view of the connector connection structure in a divided state.

FIG. 4 is an exploded perspective view of a device-side connector.

FIG. 5 is an exploded perspective view of the device-side connector.

FIG. 6 shows perspective views of the device-side connector provided for illustration of assembly.

FIG. 7 illustrates the device-side connector.

FIG. 8 is an exploded perspective view of a harness-side connector.

FIG. 9 is an exploded perspective view of the harness-side connector.

FIG. 10 shows perspective views of a terminal-attached harness provided for illustration.

FIG. 11 illustrates the terminal-attached harness.

FIG. 12 shows perspective views of the terminal-attached harness provided for illustration of assembly.

FIG. 13 illustrates the harness-side connector.

FIG. 14 illustrates the connector connection structure.

FIG. 15 illustrates other embodiments.

### DESCRIPTION OF EMBODIMENTS

An embodiment of the present invention will be described in detail with reference to the drawings.

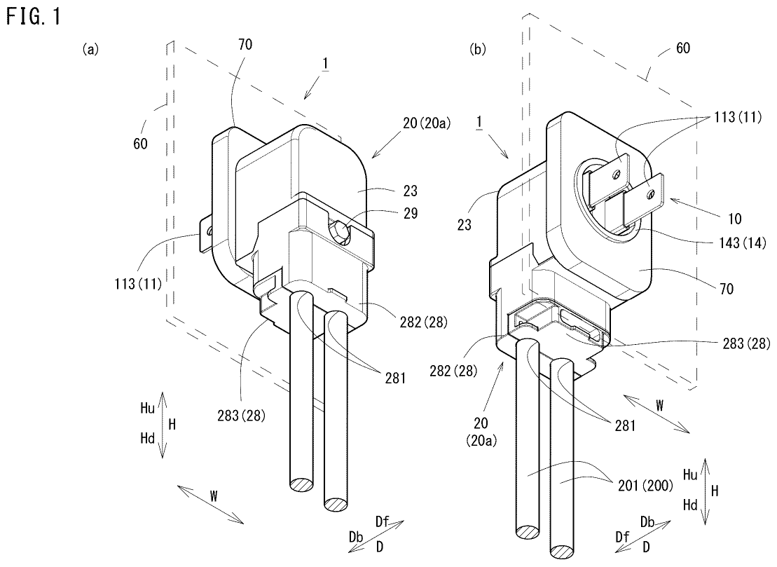

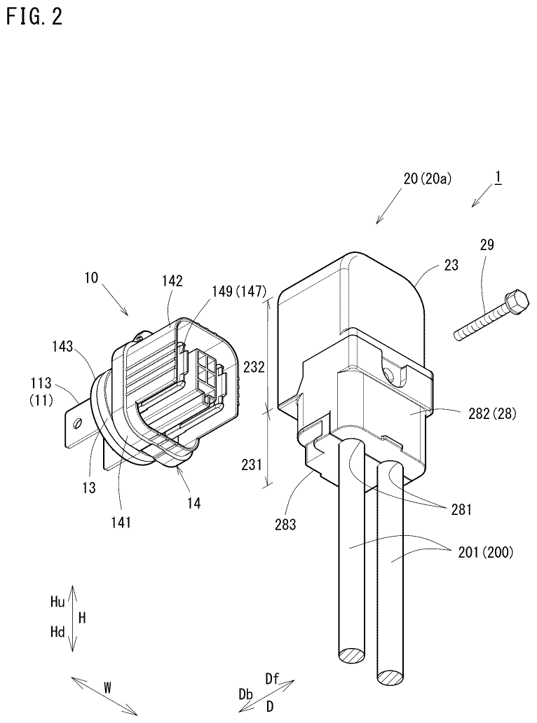

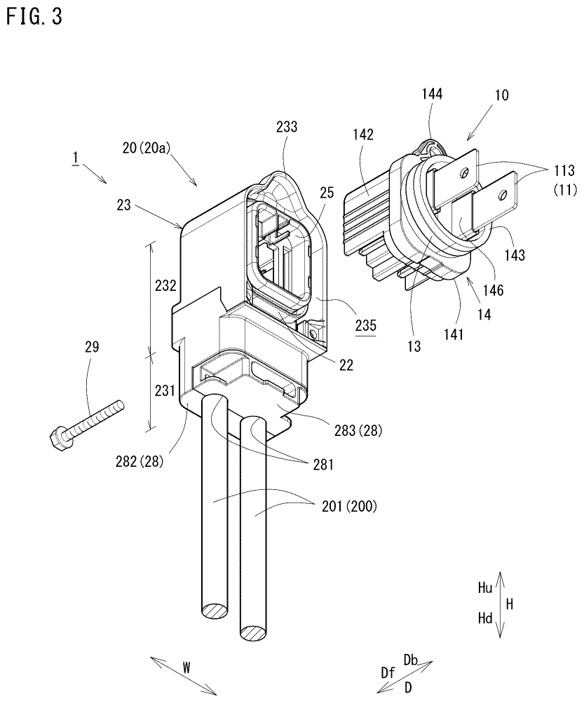

FIG. 1 illustrates a connector connection structure 1, and FIG. 2 and FIG. 3 are each a perspective view of the connector connection structure 1 in a divided state.

This will be described in more detail. FIG. 1(a) is a perspective view showing a front surface, a left side surface and a bottom surface of the connector connection structure 1, and FIG. 1(b) is a perspective view showing a rear surface, a right side surface and the bottom surface of the connector connection structure 1. FIG. 2 is an exploded perspective view showing the front surface, the left side surface and the bottom surface of the connector connection structure 1. FIG. 3 is an exploded perspective view showing the rear surface, the right side surface and the bottom surface of the connector connection structure 1.

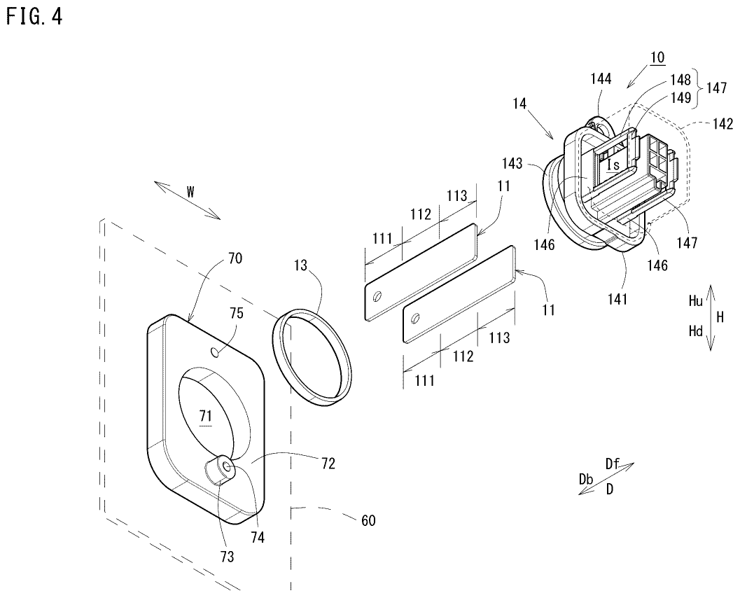

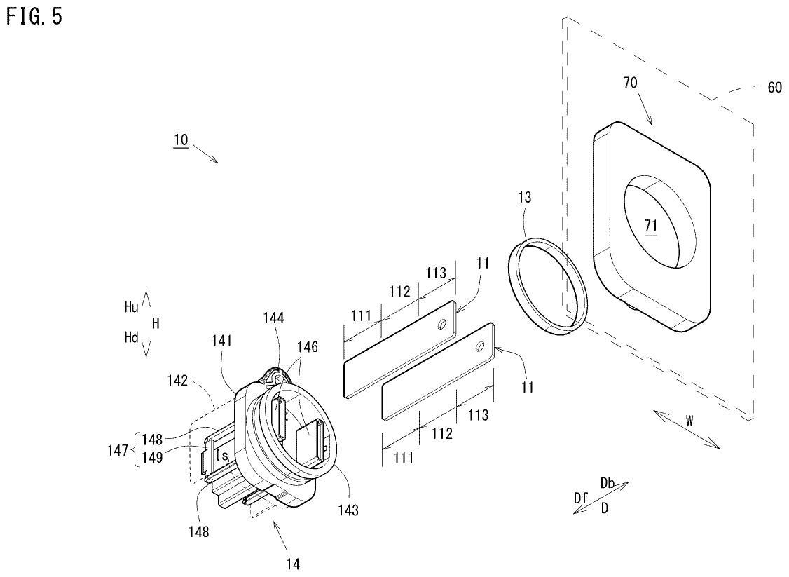

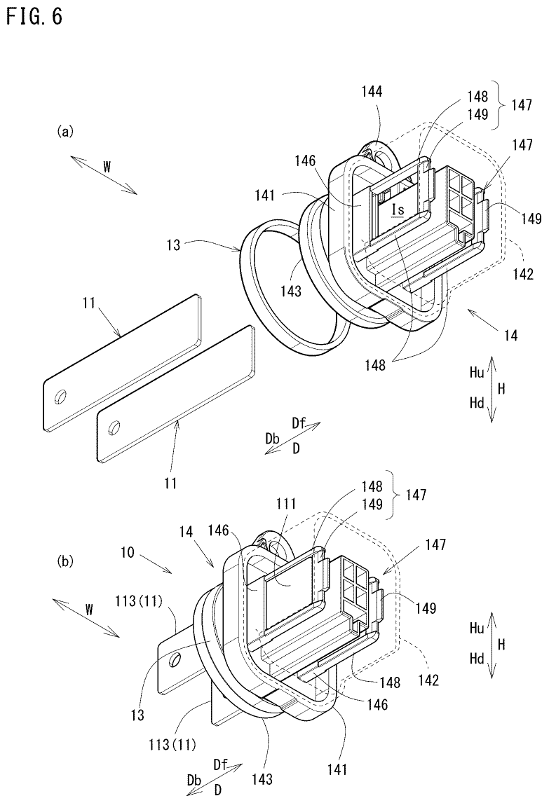

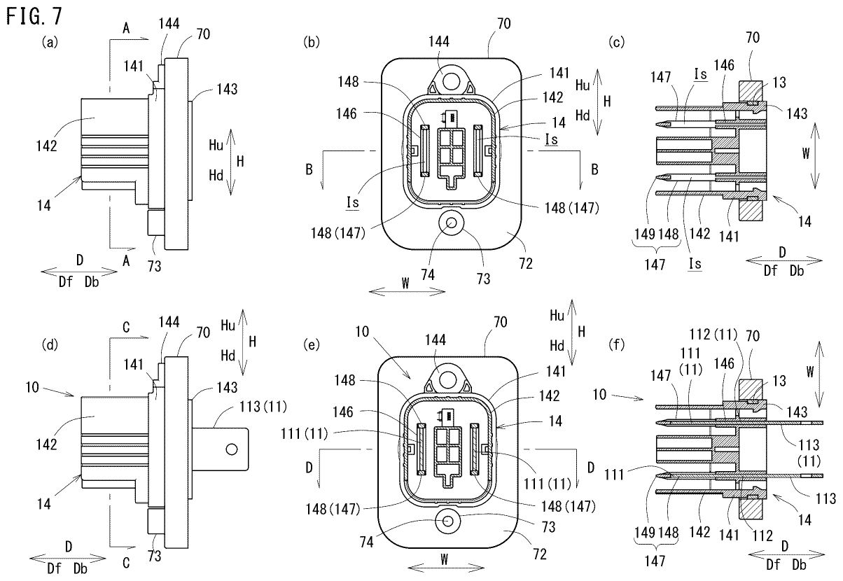

FIG. 4 and FIG. 5 each show an exploded perspective view of a device-side connector 10. FIG. 6 shows perspective views of the device-side connector 10 provided for illustration of assembly. FIG. 7 illustrates the device-side connector 10.

This will be described in more detail. FIG. 4 is an exploded perspective view showing a front surface, a left side surface bottom surface of the device-side connector 10. FIG. 5 is an exploded perspective view showing a rear surface, a right side surface and the bottom surface of the device-side connector 10.

FIG. 6(a) is a perspective view showing the front surface, the left side surface and the bottom surface of the device-side connector 10 in a divided state. FIG. 6(b) is a perspective view showing the front surface, the left side surface and the bottom surface of the device-side connector 10. In FIG. 4 through FIG. 6, a hood portion 142 of a male housing 14 in the device-side connector 10 is shown as being transparent.

FIG. 7(a) shows the right side surface of the device-side connector 10 before a male terminal 11 is incorporated thereto. FIG. 7(b) is a cross-sectional view of FIG. 7(a) taken along line A-A in FIG. 7(a). FIG. 7(c) is a cross-sectional view of FIG. 7(b) taken along line B-B in FIG. 7(b). FIG. 7(d) shows the right side surface of the device-side connector 10 with the male terminal 11 being incorporated thereto. FIG. 7(e) is a cross-sectional view of FIG. 7(d) taken along line C-C in FIG. 7(d). FIG. 7(f) is a cross-sectional view of FIG. 7(e) taken along line D-D in FIG. 7(e).

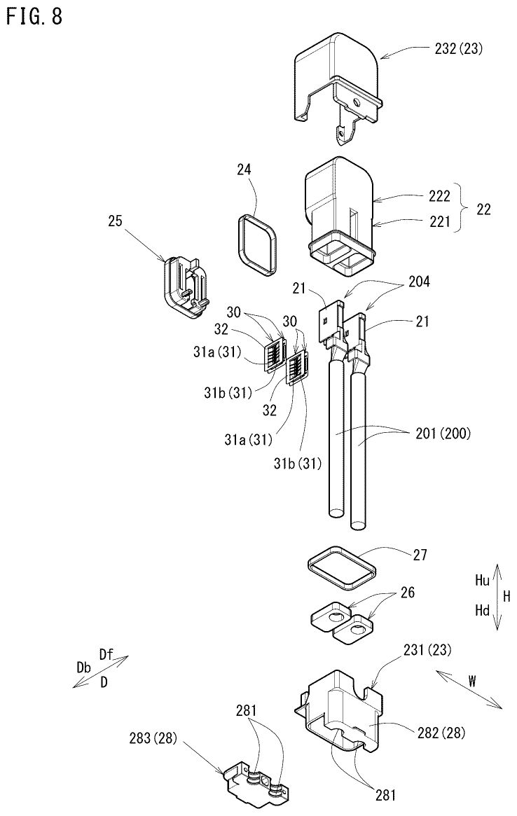

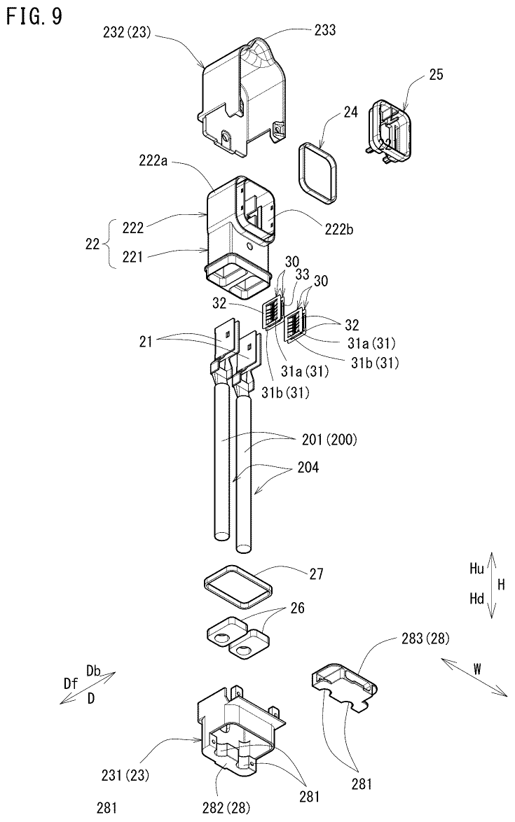

FIG. 8 is an exploded perspective showing a front surface, a left side surface and a bottom surface of a harness-side connector 20. FIG. 9 is an exploded perspective showing a rear surface, a right side surface and the bottom surface of the harness-side connector 20.

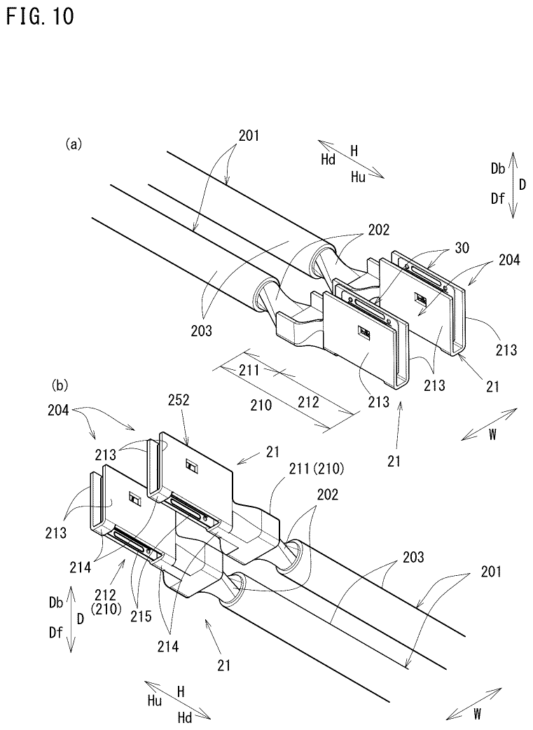

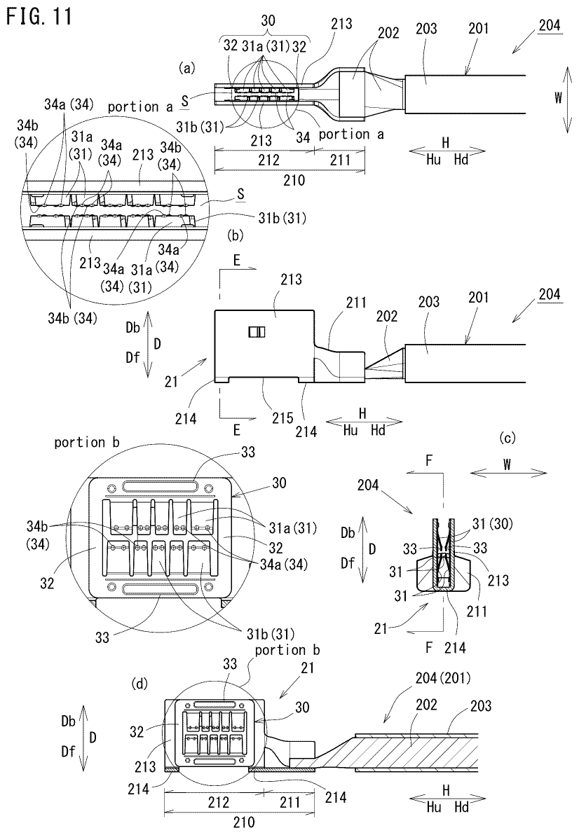

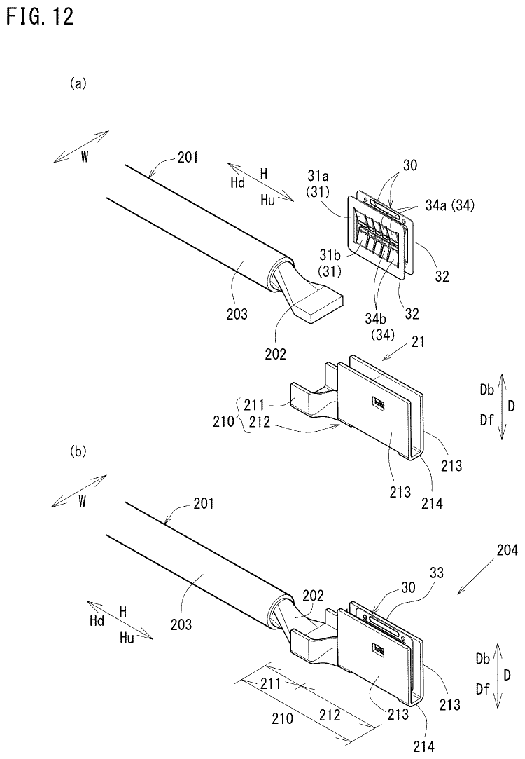

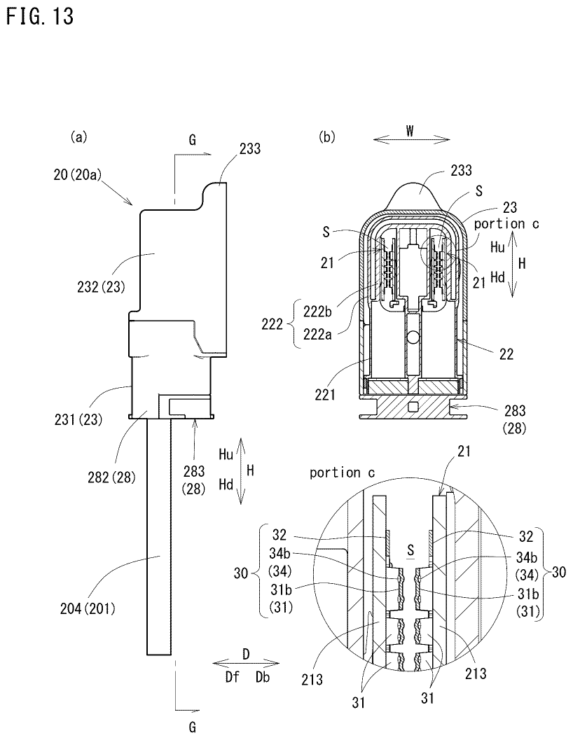

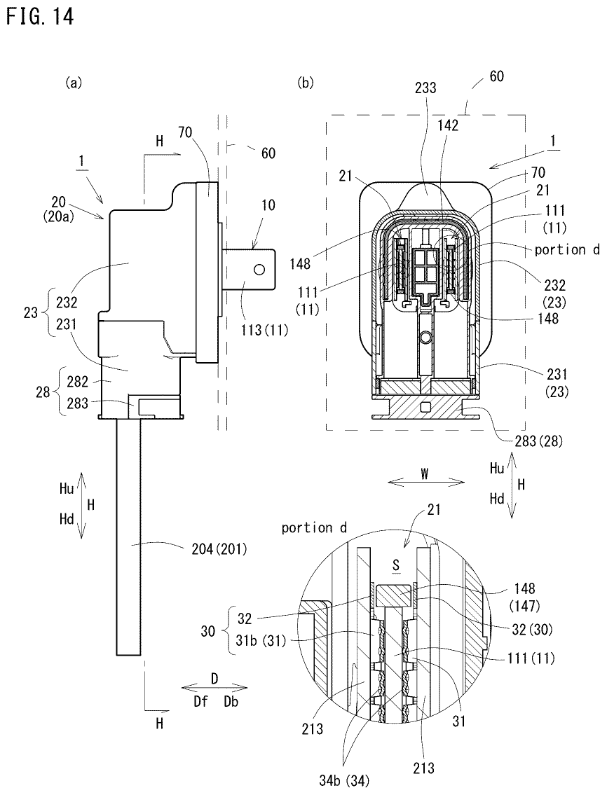

FIG. 10 shows perspective views of a terminal-attached harness 204 provided for illustration. FIG. 11 illustrates the terminal-attached harness 204. FIG. 12 shows perspective views of the terminal-attached harness 204 provided for illustration of assembly. FIG. 13 illustrates the harness-side connector 20. FIG. 14 illustrates the connector connection structure 1.

This will be described in more detail. FIG. 10(a) is a perspective view showing a rear surface, a left side surface and a top surface of the terminal-attached harness 204, which is provided in the harness-side connector 20. FIG. 10(b) is a perspective view showing a front surface, a right side surface and the top surface of the terminal-attached harness 204.

FIG. 11(a) is a rear view of the terminal-attached harness 204. FIG. 11(b) is a right side view of the terminal-attached harness 204. FIG. 11(c) is a cross-sectional view of FIG. 11(b) taken along line E-E in FIG. 11(b). FIG. 11(d) is a cross-sectional view of FIG. 11(c) taken along line F-F in FIG. 11(c). In FIG. 11, portion a in FIG. 11(a) is shown as being enlarged, and portion b in FIG. 11(d) is shown as being enlarged.

FIG. 12(a) is a perspective view showing the rear surface, the left side surface and the top surface of the terminal-attached harness 204 in a divided state. FIG. 12(b) is a perspective view showing the rear surface, the left side surface and the top surface of the terminal-attached harness 204.

FIG. 13(a) is a right side view of the harness-side connector 20, and FIG. 13(b) is a cross-sectional view of FIG. 13(a) taken along line G-G in FIG. 13(a). In FIG. 13, portion c in FIG. 13(b) is shown as being enlarged.

FIG. 14(a) is a right side view of the connector connection structure 1. FIG. 14(b) is a cross-sectional view of FIG. 14(a) taken along line H-H in FIG. 14(a). In FIG. 14, portion d in FIG. 14(b) is shown as being enlarged.

Referring to FIG. 1(a), the up-down direction is defined as a height direction H, a direction connecting the top left and the bottom right is defined as a width direction W, and the direction connecting the bottom left and the top right is defined as a depth direction D. Regarding the up-down direction, i.e., the height direction H, the top side is defined as a top side Hu and the bottom side is defined as a bottom side Hd. Regarding the depth direction D connecting the bottom left and the top right, the top right side is defined as a front side Df and the bottom left side is defined as a back side Db.

In the description of the configuration of the connector connection structure 1, the direction in which the device-side connector 10 and the harness-side connector 20 are attached to, or detached from, each other is defined as the depth direction D for the sake of convenience. The direction in which the harness-side connector 20 is attached to the device-side connector 10 is defined as the back side Db, and the direction in which the harness-side connector 20 is detached from the device-side connector 10 is defined as the front side Df. The directions perpendicular to the depth direction D are defined as the width direction W and the height direction H. These directions are not intended to define any direction regarding the configurations of the device-side connector 10, the harness-side connector 20 and the connector connection structure 1, but the above-described directions are used in the drawings attached to this specification.

The female terminal 21 according to the present invention allows the state of attachment of spring plate members 30, each including a plurality of arm springs 31 arranged in the height direction H, to the female terminal 21 to be managed by positions of contact points 34 (34a, 34b) on the arm springs 31 being checked.

For this purpose, the female terminal 21 includes a terminal main body 210 connected to a high-voltage electric wire 201 and the spring plate members 30 attached to the terminal main body 210. The terminal main body 210 includes a pair of side walls 213, which are located apart from each other by a predetermined distance and form an insertion space S, into which a plate-like connection portion 111 of the male terminal 11 is insertable.

The spring plate members 30 each include the plurality of arm springs 31 contacting the plate-like connection portion 111 of the male terminal 11 inserted into the insertion space S. The arm springs 31 are arranged to extend in parallel with the depth direction D, in which the plate-like connection portion 111 of the male terminal 11 is inserted into the insertion space S. A plurality of the arm springs 31 are lined up along the depth direction D, and a plurality of the arm springs 31 are lined up along the height direction H perpendicular to the width direction W, in which the side walls 213 face each other, and also perpendicular to the depth direction D.

The arm springs 31 are provided with the contact points 34 protruding so as to contact the plate-like connection portion 111 of the male terminal 11. The contact points 34 (34a, 34b) on the plurality of arm springs 31 (31a, 31b) lined up along the depth direction D are shifted in the height direction H. That is, the contact points 34 (34a, 34b) on the plurality of arm springs 31 (31a, 31b) lined up along the depth direction D are located at different positions from each other in the height direction H.

Therefore, the state of attachment of the spring plate members 30, each including the plurality of arm springs 31 arranged in the depth direction D, to the female terminal 21 may be managed by the positions of the contact points 34 (34a, 34b) being checked.

The harness-side connector 20 including the above-described female terminal 21, the device-side connector 10, and the connector connection structure 1 including the device-side connector 10 and the harness-side connector 20 connected to each other will be described below in detail.

As shown in FIG. 1 through FIG. 3, the connector connection structure 1 includes, for example, the device-side connector 10 connected to an electric circuit leading to an electric device such as, for example, electric equipment such as a motor or the like mounted on an automobile or the like or a power source device, and the harness-side connector 20 attached to a wire harness 200 including a bundle of the high-voltage electric wires 201. The device-side connector 10 and the harness-side connector 20 are put into engagement with, and connected to, each other in the depth direction D. Thus, a connection state that is electrically and physically stable is established.

First, with reference to FIG. 4 through FIG. 7, the device-side connector 10 attached to an attachment table 70 provided in a device casing 60 accommodating the electric device will be described.

The attachment table 70 is attached to the device casing 60 partially shown with the dashed line, and secures the male housing 14 and the harness-side connector 20 described below.

As shown in FIG. 4, the attachment table 70 has a through-hole 71 formed at a center thereof as seen in a front view thereof and running therethrough in the depth direction D. The attachment table 70 has a rectangular shape longer in the height direction H than in the width direction W, and has a predetermined thickness in the depth direction D.

A main surface on the front surface side of the attachment table 70 is defined as a securing main surface 72 securing the harness-side connector 20 attached thereto. On the bottom side Hd of the securing main surface 72 with respect to the through-hole 71, a cylindrical securing protrusion 73 protruding toward the front side Df is provided. At a tip of the securing protrusion 73, a screwing hole 74, to which a securing bolt 29 (see FIG. 2 and FIG. 3) securing the harness-side connector 20 is screwed, is provided.

On the top side Hu of the securing main surface 72 with respect to the through-hole 71, a screwing hole 75, to which the male housing 14 described below is secured by a securing bolt (not shown), is provided at a center in the width direction W. The attachment table 70 having such a configuration is formed of a metal material.

The screwing hole 75, to which the securing bolt (not shown) is screwed to secure the male housing 14, and the screwing hole 74 provided in the securing protrusion 73 securing the harness-side connector 20 to the attachment table 70 through screwing, are provided at positions, at the attachment table 70, facing each other in the height direction H while having the through-hole 71 therebetween, to which the male terminal 11 is attached.

The attachment table 70 having such a configuration is attached to the device casing 60, accommodating the electric device, by any appropriate method.

As shown in FIG. 4 and FIG. 5, the device-side connector 10 attached to the attachment table 70 attached to the device casing 60 includes the male terminals 11, a device-side seal 13, the male housing 14, and a securing bolt (not shown).

The male terminals 11 are connected to an electric circuit leading to the electric device located inside the device casing 60, and are also connected to the female terminals 21 located inside the harness-side connector 20. Two such male terminals 11 are provided apart from each other in the width direction W by a predetermined distance.

The male terminals 11 are each formed of a metal plate, and each include the plate-like connection portion 111, a coupling portion 112 and a circuit connection portion 113, which are arranged in this order from the back side Db toward the front side Df in the depth direction D.

The plate-like connection portion 111 connects the harness-side connector 20 and the device-side connector 10 to each other and thus is inserted into the insertion space S formed between the side walls 213 of the terminal connection portion 212 of the corresponding female terminal 21. In this manner, the plate-like connection portion 111 is connected to the female terminal 21 via the corresponding spring plate members 30.

The coupling portion 112 couples the plate-like connection portion 111 and the circuit connection portion 113 to each other. The circuit connection portion 113 is connected to the electric circuit (not shown) leading to the electric device located inside the device casing 60.

The plate-like connection portion 111, the coupling portion 112 and the circuit connection portion 113 are continuously formed in the depth direction D, and main surfaces thereof are planar and extend in the height direction H and the width direction W. The plate-like connection portion 111 connected to the female terminal 21 is located inside the hood portion 142 of the male housing 14 described below, and protrudes toward the front side Df beyond a main body 141 of the male housing 14 described below.

The coupling portion 112 continuous from the plate-like connection portion 111 is formed to have such a length as to run through the main body 141 and an insertion cylinder 143 of the male housing 14 described below in the depth direction D. The circuit connection portion 113 is formed so as to protrude toward the back side Db beyond the insertion cylinder 143.

The device-side seal 13 is attached to the insertion cylinder 143 of the male housing 14 described below and seals a gap between the insertion cylinder 143 of the male housing 14 and the attachment table 70. The device-side seal 13 is ring-shaped and is formed of rubber.

The male housing 14 holds the male terminals 11 in the attachment table 70. The male housing 14 includes the main body 141 holding the male terminals 11, the hood portion 142 enclosing the male terminals 11 held by the main body 141, the insertion cylinder 143, having a cylindrical shape, inserted into the through-hole 71 of the attachment table 70, and a securing protrusion 144 securing the male housing 14 to the attachment table 70 by the securing bolt (not shown).

The main body 141 is formed to have a generally rectangular shape that is slightly longer in the height direction H than in the width direction W as seen in the depth direction D.

The main body 141 is provided with a terminal holding portion 146 protruding toward the front side Df.

The hood portion 142 is formed to be like a circumferential wall that is opened on the front side Df and has both of two sides in the width direction W and the top side Hu protruding toward the front side Df from the main body 141. The hood portion 142 is formed such that the top side Hu protrudes more toward the front side Df than the bottom side Hd.

The insertion cylinder 143 is located on the back side Db with respect to the main body 141. The insertion cylinder 143 is formed to be like a discus having a diameter slightly shorter than the diameter of the through-hole 71 of the attachment table 70 so as to be insertable into the through-hole 71. The insertion cylinder 143 is formed to be thicker than the attachment table 70 in the depth direction D by a certain degree.

On the top side Hu of the main body 141, the securing protrusion 144 protrudes toward the top side Hu from a center in the width direction W. The securing protrusion 144 has an attachment hole through which the securing bolt (not shown) is attached to screw and secure the male housing 14 to the securing hole 75 of the attachment table 70.

As described above, in the male housing 14, the male terminals 11 to be incorporated run through the main body 141 and the insertion cylinder 143 in the depth direction D, and the male terminals 11 may be held by the terminal holding portion 146 protruding toward the front side Df beyond the main body 141. That is, the insertion cylinder 143, the main body 141 and the terminal holding portion 146 each have a through-hole running in the depth direction D through which the male terminals 11 are insertable. The male terminals 11 inserted through the through-holes are held by the male housing 14.

Extending bodies 147 protruding toward the front side Df beyond the terminal holding portion 146 protruding toward the front side Df from the main body 141 are further provided.

In each of the male terminals 11 held by the terminal holding portion 146, the extending body 147 is formed to have a gate-like frame shape as seen in the width direction W so as to be along a perimeter of the corresponding plate-like connection portion 111 protruding toward the front side Df beyond the terminal holding portion 146.

This will be described in more detail. The extending body 147 includes two columns 148 protruding toward the front side Df from the terminal holding portion 146 so as to be along side perimeters of the corresponding plate-like connection portion 111 protruding toward the front side Df beyond the terminal holding portion 146, and also includes a tip coupling portion 149 bridging tips of the columns 148 in the height direction H to connect the tips to each other such that the tip coupling portion 149 is along a tip perimeter of the corresponding plate-like connection portion 111.

The two columns 148 are located such that a distance between inner surfaces thereof corresponds to a width of the plate-like connection portion 111 in the height direction H. The tip coupling portion 149 bridging the tips of the two columns 148 forms the gate-like frame shape accommodating an inner space Is having generally the same shape as that of the plate-like connection portion 111 as seen in the width direction W.

As described above, the two columns 148 included in the extending body 147 having the gate-like frame shape are each like a column having a quadrangular cross-section. Each column 148 is formed to be thicker than the plate-like connection portion 111. The thickness of each column 148 is less than the distance between inner surfaces of the side walls 213 of the female terminal 21 connected to the male terminal 11.

More specifically, each column 148 is thicker than the plate-like connection portion 111 and is thinner than the distance between inner surfaces of spring attachment portions 32 of the spring plate members 30 provided on the inner surfaces of the side walls 213 of the female terminal 21 connected to the male terminal 11.

The tip coupling portion 149 is formed to have generally the same thickness as that of the plate-like connection portion 111 and a width larger than the thickness thereof. The tip of each column 148 and a tip, on the front side Df, of the tip coupling portion 149 are formed to become gradually thinner.

The device-side connector 10 including the elements having such configurations is integrally formed of a resin.

The device-side connector 10 including the elements having such configurations is formed by incorporating the male terminals 11 to the main body 141 of the male housing 14 and also outserting the device-side seal 13 over the insertion cylinder 143.

Specifically, the coupling portions 112 are inserted into the insertion cylinder 143, the main body 141 and the terminal holding portion 146 such that the plate-like connection portions 111 are located in the hood portion 142, and the male terminals 11 are attached to the male housing 14 such that the circuit connection portions 113 protrude toward the back side Db beyond the insertion cylinder 143. At this point, the plate-like connection portions 111 are located in the inner spaces ls of the extending bodies 147 protruding toward the front side Df from the terminal holding portion 146.

The insertion cylinder 143 of the male housing 14, to which the male terminals 11 and the device-side seal 13 are incorporated, is inserted into the through-hole 71 of the attachment table 70, and the securing bolt (not shown) attached to the securing protrusion 144 is screwed into the screwing hole 75 to secure the attachment table 70 and the male housing 14 to each other. Thus, the assembly of the device-side connector 10 is finished.

The high-voltage electric wire 201 having each male terminal 11 attached to a tip thereof is defined as a “terminal-attached harness”, and the device-side connector 10 having the male terminals 11 of the terminal-attached harnesses located therein is defined as a “connector-attached electric wire”.

Now, with reference to FIG. 8 through FIG. 13, the harness-side connector 20 connected to the above-described device-side connector 10 to form the connector connection structure 1 will be described.

The harness-side connector 20 is attached to the above-described device-side connector 10 to form the connector connection structure 1, and connects the male terminals 11 of the device-side connector 10 to the female terminals 21 located therein.

The harness-side connector 20 (20a) includes the wire harness 200, the female terminals 21 each attached to a tip of the high-voltage electric wire 201 included in the wire harness 200, an inner housing 22, a housing shell 23, a housing seal 24, a housing cover 25, wire seals 26, a shell seal 27, and an electric wire holding portion 28. The high-voltage electric wires each having the female terminal 21 attached to a tip thereof is defined as a “terminal-attached harness 204”.

The female terminals 21 are each a high-voltage terminal attached to an electric wire conductor 202 exposed from the tip of the high-voltage electric wire 201 including the electric wire conductor 202 and an insulating cover 203 covering the electric wire conductor 202. In the case of the wire harness 200 including two high-voltage electric wires 201, the female terminal 21 is attached to each of the high-voltage electric wires 201, and the harness-side connector 20 includes the two female terminals 21. The female terminals 21 will be described below in detail.

The inner housing 22 holds the two female terminals 21 at predetermined positions inside the harness-side connector 20. The inner housing 22 includes a harness insertion cylinder 221, into which the wire harness 200 is inserted, and a holding portion main body 222 holding the female terminals 21 provided at a tip of the wire harness 200 inserted into the harness insertion cylinder 221. The inner housing 22 is formed of a resin.

The harness insertion cylinder 221 is a polygonal tube having an end on the bottom side Hd (bottom end) opened. An end on the top side Hu (top end) of the harness insertion cylinder 221 is in communication with the inside of the holding portion main body 222.

On the top side Hu of the harness insertion cylinder 221, a through-hole through which the securing bolt 29 described below may run in the depth direction D is provided at a center in the width direction W.

The holding portion main body 222 is located at an end on the top side Hu of the harness insertion cylinder 221, and has a generally cuboidal shape having the back side Db opened. The holding portion main body 222 is configured to hold the female terminals 21 therein.

As shown in FIG. 9, the holding portion main body 222 includes a double-wall structure including an outer wall 222a and an inner wall 222b. The holding portion main body 222 is configured to hold the female terminals 21 inside the inner wall 222b.

In a state where the device-side connector 10 and the harness-side connector 20 are assembled together, a space into which the hood portion 142 of the male housing 14 of the device-side connector 10 is inserted is provided between the outer wall 222a and the inner wall 222b. The housing seal 24 described below is attached to this space.

The housing shell 23 covers an outer surface of the inner housing 22, and also forms an outer profile of the harness-side connector 20.

The housing shell 23 is larger than the inner housing 22 by a certain degree, and includes a harness insertion outer cylinder 231 and a shell main body 232.

This will be described in more detail. The harness insertion outer cylinder 231 is a polygonal tube larger than the harness insertion cylinder 221 by a certain degree so as to accommodate the harness insertion cylinder 221 having the wire harness 200 inserted thereinto. An end on the top side Hu of the harness insertion outer cylinder 231 is in communication with the inside of the shell main body 232.

The bottom side Hd of the harness insertion outer cylinder 231 is defined as the electric wire holding portion 28.

The shell main body 232 is located at the end on the top side Hu of the harness insertion outer cylinder 231. The shell main body 232 has a generally cuboidal shape that is larger than the holding portion main body 222, accommodated therein, by a certain degree, and has the back side Db opened.

In the shell main body 232 formed to have a generally cuboidal shape with the back side Db opened, the female terminals 21 are exposed to an engageable opening 235 (see FIG. 3) on the back side Db. The shell main body 232 includes a cover 233 on the top side Hu thereof.

The cover 233 has a triangular pyramid shape as seen in a front view that protrudes toward the top side Hu from the shell main body 232. The cover 233 is formed to enclose the securing protrusion 144 and the securing bolt (not shown) securing the male housing 14 of the device-side connector 10 to the attachment table 70 provided in the device casing 60.

The housing shell 23 accommodating the inner housing 22 is formed of a metal material, and is formed by assembling the harness insertion outer cylinder 231 and the shell main body 232.

The housing seal 24 is shaped like a ring having a generally quadrangular shape as seen in a plan view that matches the shape of the inner wall 222b, as seen in a rear view, of the holding portion main body 222, and is formed of rubber.

The housing seal 24 is outserted over the inner wall 222b of the inner housing 22. In a state where the device-side connector 10 and the harness-side connector 20 are assembled tother, the housing seal 24 seals a gap between the hood portion 142 of the male housing 14 of the device-side connector 10 described below and the inner housing 22 of the harness-side connector 20.

The housing cover 25 is attached to the inner wall 222b of the inner housing 22 from the back side Db to secure the housing seal 24 located around the holding portion main body 222 of the inner housing 22, and holds the female terminals 21 located inside the holding portion main body 222. The housing cover 25 is formed of a resin.

The wire seals 26 each have a rectangular shape as seen in a plan view that has an insertion hole 261, through which the high-voltage electric wire 201 is inserted. The wire seals 26 each seal a gap between the high-voltage electric wire 201 inserted into the harness insertion cylinder 221 and an inner surface of the harness insertion cylinder 221. Therefore, two such wire seals 26 are provided in correspondence with the two high-voltage electric wires 201.

The shell seal 27 is outserted over the harness insertion cylinder 221 of the inner housing 22, and seals a gap between the harness insertion cylinder 221 and the harness insertion outer cylinder 231. The shell seal 27 is formed to have a generally rectangular shape outsertable over the harness insertion cylinder 221.

The electric wire holding portion 28 provided at an end on the bottom side Hd of the harness insertion outer cylinder 231 holds the high-voltage electric wires 201 inserted into the harness insertion cylinder 221 to the harness insertion outer cylinder 231, and has electric wire insertion holes 281, through which the high-voltage electric wires 201 are inserted.

Two electric wire insertion holes 281 are provided apart from each other by a predetermined distance in the width direction W in correspondence with the two high-voltage electric wires 201 included in the wire harness 200. The electric wire insertion holes 281 are each formed to have a diameter equal to, or slightly shorter than, an outer diameter of each high-voltage electric wire 201 inserted through the electric wire insertion holes 281.

The electric wire holding portion 28 provided on the bottom side Hd of the harness insertion outer cylinder 231 includes a securing-side holding portion 282 formed integrally with the harness insertion outer cylinder 231 and an attachable holding portion 283 attachable to the securing-side holding portion 282, and also includes a securing bolt (not shown) securing the attachable holding portion 283 attached to the securing-side holding portion 282.

The attachable holding portion 283 is attached to the securing-side holding portion 282 of the harness insertion outer cylinder 231 and the securing bolt (not shown) is screwed thereto, and as a result, the attachable holding portion 283 may be secured to the securing-side holding portion 282 to form the electric wire holding portion 28.

The harness-side connector 20 including the elements having such configurations is engaged with, and connected to, the device-side connector 10 by the securing bolt 29 described below, and thus the connection state is secured. The securing bolt 29 is formed of a metal material, and has a bolt head provided at an end of a screw shaft screwed into the screwing hole 74 provided in the securing protrusion 73 of the attachment table 70.

Now, with reference to FIG. 10 through FIG. 12, the female terminals 21 located inside the above-described harness-side connector 20 will be described.

As described above, the female terminals 21 are each a high-voltage terminal connected to the corresponding electric wire conductor 202 exposed from the insulating cover 203 at the tip of the corresponding one of the two high-voltage electric wires 201. The high-voltage electric wires 201 each having the female terminal 21 connected to the tip thereof is defined as the “terminal-attached harness 204”.

As described above, the female terminal 21 included in the terminal-attached harness 204 includes a terminal main body 210 including an electric wire connection portion 211 connected to the electric wire conductor 202 of the high-voltage electric wire 201 and a terminal connection portion 212 connected to the plate-like connection portion 111 (FIG. 10) of the male terminal 11. The electric wire connection portion 211 and the terminal connection portion 212 are arranged in this order in the height direction H from the bottom side Hd toward the top side Hu.

As shown in FIG. 11(c), the electric wire connection portion 211 is formed to have a square-cornered U shape with the back side Db opened as seen in the height direction H.

The terminal connection portion 212 includes the two side walls 213 located away from each other by a predetermined distance in the width direction W and bottom coupling portions 214 coupling bottom ends of the side walls 213. The terminal connection portion 212 including the side walls 213 and the bottom coupling portions 214 is generally U-shaped and has the back side Db opened as seen in the height direction H. The space between the side walls 213 facing each other in the width direction W is the insertion space S (see FIG. 11), through which the plate-like connection portion 111 of the male terminal 11 described below is inserted for connection.

The side walls 213 each have a rectangular shape that is longer in the height direction H than in the depth direction D, as seen in the width direction W. Two such bottom coupling portions 214 are located away from each other by a predetermined distance in the height direction H, and therefore, a through-opening 215 running in the depth direction D is formed between the bottom coupling portions 214 (see FIG. 10(b)).

The spring plate members 30 are respectively provided on the inner surfaces of the pair of side walls 213 facing each other in the width direction W.

The spring plate members 30 are each formed to be generally square by a metal plate being punched out. Each of the spring plate members 30 includes ten arm springs 31 contacting the plate-like connection portion 11 (see FIG. 13) of the male terminal 11 and a spring attachment portion 32 enclosing the arm springs 31 and attaching the arm springs 31 to the corresponding side wall 213.

The spring attachment portion 32 is formed to be generally square. The spring attachment portion 32 supports the arm springs 31 extending toward the inner side in the depth direction D, and includes welding portions 33 securing the arm springs 31 to the inner surface of the corresponding side wall 213 (see FIG. 11(d)).

Five of the ten arm springs 31 are provided on the back side Db, and are located to be in parallel with each other in the height direction H. These five arm springs 31 are supported by the spring attachment portion 32 on the back side Db, and extend toward the front side Df. The remaining five arm springs 31 are provided on the front side Df, and are located to be in parallel with each other in the height direction H. These five arm springs 31 are supported by the spring attachment portion 32 on the front side Df, and extend toward the back side Db. The number of the arm springs 31 is not limited to the above-mentioned number, and may be any appropriate number.

As described above, the arm springs 31 of the spring plate member 30 are arranged in two rows in the depth direction D. The five arm springs 31 extending from the back side Db, on which these five arm springs 31 are supported by the spring attachment portion 32, toward the front side Df are defined as opening-side arm springs 31a, which are closer to an opening of the insertion space S. The five arm springs 31 extending from the front side Df, on which these five arm springs 31 are supported by the spring attachment portion 32, toward the back side Db are defined as coupling-side arm springs 31b, which are closer to the bottom coupling portions 214.

As shown in the enlarged view of the portion b in FIG. 11(d), the five opening-side arm springs 31a closer to the opening of the insertion space S, and the five coupling-side arm springs 31b closer to the bottom coupling portions 214 are shifted from each other in the height direction H. Specifically, the opening-side arm springs 31a and the coupling-side arm springs 31b are shifted from each other in the height direction H by a distance that is approximately half of a distance between two contact points 34 provided on inner arm springs 31 among five arm springs 31 included in each line and arranged in the height direction H.

Among the arm springs 31 located to be in parallel with each other and arranged in the height direction H, more specifically, among the opening-side arm springs 31a, two arm springs 31 at the ends are formed to be wider than the other arm springs 31. Among the coupling-side arm springs 31b, two arm springs 31 at the ends are formed to be wider than the other arm springs 31.

The arm springs 31 each having a base portion supported by the spring attachment portion 32 as described above gradually protrude toward tips thereof, and are each provided with the contact points 34, protruding in the width direction W, at, or in the vicinity of, the tip thereof.

The contact points 34 are each bent at the tip of the corresponding arm spring 31 so as to protrude toward the other side in the width direction W. Two such contact points 34 each having such a configuration are formed at the tip of each arm spring 31 while being apart from each other by a predetermined distance in the height direction H. Specifically, the two contact points 34 are formed to be away from each other by a distance that is approximately half of the width at the tip of each of the inner arm springs 31 among the five arm springs 31 arranged in the height direction H. The contact points 34 on the opening-side arm springs 31a are each defined as an “opening-side contact point 34a”, and the contact points 34 on the coupling-side arm springs 31b are each defined as a “coupling-side contact point 34b”.

The contact points 34 are formed at the same positions of the arm springs 31 in the depth direction D. Therefore, the opening-side contact points 34a and the coupling-side contact points 34b respectively provided on the opening-side arm springs 31a and the coupling-side arm springs 31b, which are shifted from each other in the height direction H, are shifted from each other in the height direction H. As shown in the enlarged view of portion a in FIG. 11(a), the opening-side contact points 34a on the opening-side arm springs 31a and the coupling-side contact points 34b on the coupling-side arm springs 31b are visually recognizable from the back side Db of the terminal connection portion 212.

The spring plate members 30 each having such a configuration are respectively attached to the inner surfaces of the pair of side walls 213, and thus are located to face each other. Two such spring plate members 30 are used in combination, and are configured to have urging forces acting to sandwich the plate-like connection portion 111, inserted into the insertion space S, in the width direction W.

At this point, as described above, regarding one same spring plate member 30, the opening-side contact points 34a on the opening-side arm springs 31a on the back side Db, and the coupling-side contact points 34b on the coupling-side arm springs 31b on the front side Df, are shifted from each other in the height direction H. However, the opening-side contact points 34a on the opening-side arm springs 31a of the spring plate member 30 attached to the inner surface of one of the side walls 213, and the contact points 34a on the arm parings 31a of the spring plate member 30 attached to the inner surface of the other side wall 213 facing the one side wall 213 in the width direction 213, are located at the same positions as each other in the height direction H and face each other in the width direction W. The coupling-side contact points 34b on the coupling-side arm springs 31b of the spring plate member 30 attached to the inner surface of one of the side walls 213, and the contact points 34b on the arm springs 31b of the spring plate member 30 attached to the inner surface of the other side wall 213 facing the one side wall 213 in the width direction W, are located at the same positions as each other in the height direction H and face each other in the width direction W.

Regarding the female terminal 21 including the spring plate members 30 respectively attached to the inner surfaces of the side walls 213 of the terminal connection portion 212, the distance between the contact points 34 facing each other in the width direction W is measured from the back side Db of the side walls 213 for inspection and management on, for example, whether or not the arm springs 31 of the spring plate members 30 may have desired urging forces, and whether or not the arm springs 31 are located at predetermined positions with respect to the side walls 213. The distance between the opening-side contact points 34a on the opening-side arm springs 31a on the back side Db, and also the distance between the coupling-side contact points 34b on the coupling-side arm springs 31b shifted from the opening-side contact points 34a in the height direction H, may be measured from the back side Db of the side walls 213 for inspection and management.

The terminal-attached harnesses 204 each include the electric wire connection portion 211 of the female terminal 21 including the above-described spring plate members 30 secured to the inner surfaces of the side walls 213 facing each other in the width direction W, and also includes the electric wire conductor 202, of the high-voltage electric wire 201, connected to the electric wire connection portion 211. As shown in FIG. 13(b), the harness-side connector 20 accommodating the termina-attached harnesses 204 causes the female terminals 21 located apart from each other by a predetermined distance in the width direction W to be exposed toward the back side Db from the engageable opening 235.

The terminal-attached harnesses 204 each include the female terminal 21 attached to the tip of the high-voltage electric wire 201. The housing shell 23 accommodating the female terminals 21 of the terminal-attached harnesses 204 is defined as a “connector-attached electric wire 20a”.

The device-side connector 10 attached to the attachment table 70 attached to the device casing 60, and the harness-side connector 20 provided at the tip of the wire harness 200, are put into engagement with each other to connect the male terminals 11 of the device-side connector 10 and the female terminals 21 of the harness-side connector 20 to each other. As a result, as shown in FIG. 14, the connector connection structure 1 may be formed.

Specifically, the harness-side connector 20 provided at the tip of the wire harness 200 is moved toward the back side Db, that is, toward the device-side connector 10 attached to the attachment table 70 attached to the device casing 60. Then, the hood portion 142 of the device-side connector 10 and the plate-like connection portions 111 of the male terminals 11 are inserted into the harness-side connector 20 from the engageable opening 235 of the harness-side connector 20.

This will be described in more detail. In the harness-side connector 20, the hood portion 142 of the device-side connector 10 is inserted between the outer wall 222a and the inner wall 222b having the housing seal 24 attached thereto.

The plate-like connection portions 111 of the male terminals 11 of the device-side connector 10 are each inserted, together with the extending body 147, into the insertion space S between the side walls 213 of the corresponding female terminal 21 exposed from the engageable opening 235.

When the plate-like connection portion 111 is inserted into the insertion space S, the arm springs 31 (31a, 31b) of the spring plate members 30 secured to the inner surfaces of the side walls 213 by the welding portions 33 are urged to sandwich the plate-like connection portion 111 from both of the two sides in the width direction W. Thus, the contact points 34 (34a, 34b) contact the plate-like connection portion 111. As a result, the male terminal 11 and the corresponding female terminal 12 are connected to each other via the spring plate members 30 in an electrically conductive manner.

At this point, the columns 148 of the extending body 147 inserted into the insertion space S together with the plate-like connection portion 111 are located between the spring attachment portions 32, facing each other in the width direction W, of the spring plate members 30 respectively secured to the inner surfaces of the side walls 213 facing each other in the width direction W. Therefore, the columns 148 of the extending body 147 contacts at least one of the spring attachment portions 32 of the spring plate members 30 facing each other in the width direction W, or is located to be away from at least one of the spring attachment portions 32 by a slight gap provided in the width direction W.

Therefore, in the male housing 14 accommodating the extending bodies 147 including the columns 148, the male terminals 11 may each be inserted into the insertion space S of the corresponding female terminal 21 in a state where in the insertion space S, the columns 148 are restricted by the spring attachment portions 32 facing each other in the width direction W and where the relative orientation and posture of the male terminal 11 with respect to the female terminal 21 are restricted.

In the insertion spaces S, the columns 148 are restricted by the spring attachment portions 32 facing each other in the width direction W. Therefore, even in a connection state where the plate-like connection portion 111 is inserted into the insertion space S of the female terminal 21, the relative orientation and posture of the male terminal 11 with respect to the female terminal 21 may be restricted. Thus, the connection state may be stabilized.

As described above, the female terminals 21 each include the terminal main body 210 connected to the high-voltage electric wire 201 and the spring plate members 30 attached to the terminal main body 210. The terminal main body 210 includes the pair of side walls 213 located apart from each other by a predetermined distance and forming the insertion space S, into which the male terminal 11 is insertable. The spring plate members 30 each include the plurality of arm springs 31 (31a, 31b) contacting the male terminal 11 inserted into the insertion space S.

The arm springs 31 (31, 31b) are arranged to extend in parallel with the depth direction D, in which the male terminals 11 are inserted into the insertion spaces S. A plurality of the arm springs 31 (31, 31b) are lined up along the depth direction D, and a plurality of the arm springs 31 (31, 31b) are lined up along the height direction H perpendicular to the width direction W, in which the side walls 213 face each other, and also perpendicular to the depth direction D. The arm springs 31 (31a, 31b) are provided with the contact points 34 (34a, 34b) protruding so as to contact the male terminals 11.

In each of the female terminals 21, the contact points 34 (34a, 34b) on the plurality of arm springs 31 (31a, 31b) lined up along the depth direction D are shifted from each other in the height direction H. Therefore, regarding the female terminals 21, the harness-side connector 20 including the female terminals 21, the terminal-attached harnesses 204, the connector-attached electric wire 20 and the wire harness 200, the state of attachment of the spring plate members 30, including the plurality of arm springs 31 (31a, 31b) arranged in the depth direction D, to the female terminals 21 may be checked and managed by the positions of the contact points 34 (34a, 34b) being checked from the back side Db.

This will be described in more detail. The terminal main body 210 includes the pair of side walls 213 located apart from each other by a predetermined distance and forming the insertion space S, into which the male terminal 11 is insertable, and is connected to the high-voltage electric wire 201. The spring plate member 30 attached to the terminal main body 210 includes the plurality of arm springs 31 (31a, 31b) contacting the male terminal 11 inserted into the insertion space S. The arm springs 31 (31a, 31b) are arranged to extend in parallel with the depth direction D, in which the male terminal 11 is inserted into the insertion space S, and a plurality of the arm springs 31 are lined up along the depth direction D and a plurality of the arm springs 31 are lined up along the height direction H perpendicular to the width direction W, in which the side walls 213 face each other, and also perpendicular to the depth direction D.

The arm springs 31 (31a, 31b) are provided with the contact points 34 (34a, 34b) protruding so as to contact the male terminal 11, and the contact points 34 (34a, 34b) on the plurality of arm springs 31 (31a, 31b) lined up along the depth direction D are shifted from each other in the height direction H. Therefore, the contact points 34 (34a, 34b) shifted from each other in the height direction H while being provided on the plurality of arm springs 31 (31a, 31b) lined up along the depth direction D may be checked from the back side Db of the terminal connection portion 212.

Therefore, regarding each female terminal 21 including the spring plate members 30 respectively attached to the inner surfaces of the side walls 213 of the terminal connection portion 212, the distance between the opening-side contact points 34a on the opening-side arm springs 31a on the back side Db, and also the distance between the coupling-side contact points 34b on the coupling-side arm springs 31b on the front side Df shifted from the opening-side contact points 34a, may be measured from the back side Db of the side walls 213 for inspection and management on, for example, whether or not the arm springs 31 (31a, 31b) of the spring plate members 30 may have desired urging forces and whether or not the arm springs 31 (31a, 31b) are located at predetermined positions with respect to the side walls 213.

The plurality of arm springs 31 (31a, 31b) lined up along the depth direction D are shifted from each other in the height direction H. Therefore, the contact points 34 (34a, 34b) on the plurality of arm springs 31 (31a, 31b) lined up along the depth direction D may be shifted from each other in the height direction H with certainty.

The arm springs 31 (31a, 31b) are arranged in two rows in the depth direction D. The opening-side arm springs 31a protrude in the width direction W when forming them from the back side Db toward the front side Df in the depth direction D, and the coupling-side arm springs 31b protrude in the width direction W when forming them from the front side Df toward the back side Db. Therefore, the opening-side contact points 34a on the opening-side arm springs 31a and the coupling-side contact points 34b on the coupling-side arm springs 31b become closer to each other in the depth direction D. Thus, the state of attachment of the spring plate member 30 to the female terminal 21 may be easily managed by the contact points 34 (34a, 34b).

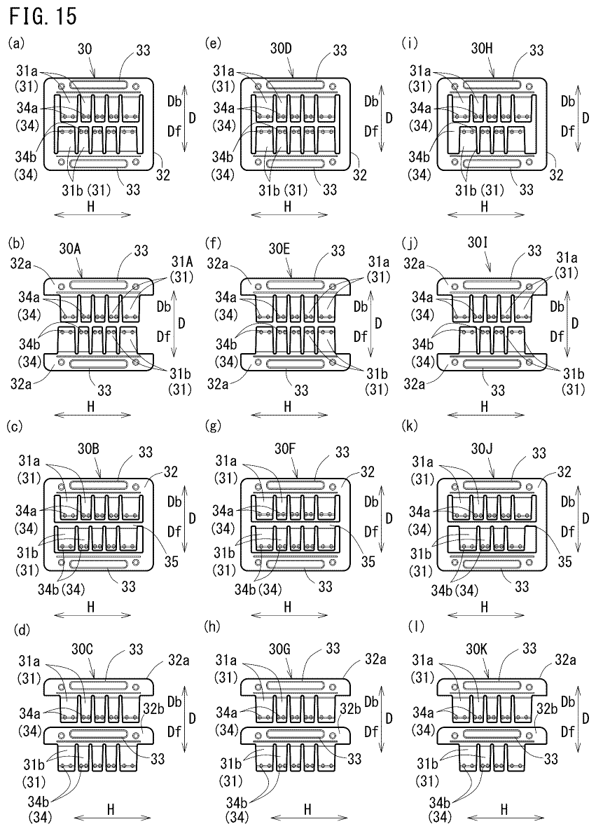

As shown in FIG. 15(a), the above-described spring plate members 30 are each configured such that the positions of the contact points 34 with respect to the arm springs 31 are the same as each other and such that the opening-side arm springs 31a on the back side Db and the coupling-side arm springs 31b on the front side Df are positionally shifted from each other in the height direction H. Thus, the opening-side contact points 34a and the coupling-side contact points 34b are shifted from each other in the height direction H. The spring plate members 30 are each configured to support the arm springs 31 by the spring attachment portion 32 having a square-frame shape.

By contrast, as shown in FIG. 15(b), a spring plate member 30A may be configured such that the arm springs 31 are supported by band-like spring attachment portions 32a extending in the height direction H, instead of the spring attachment portion 32 having the square-frame shape, and are attached to the inner surface of each side wall 213 by the welding portions 33.

In this case, one band-like spring attachment portion 32a of the spring plate 30A is located on the back side Db of the opening-side arm springs 31a extending from the back side Db toward the front side Df, and another band-like spring attachment portion 32a of the spring plate 30A is located on the front side Df of the coupling-side arm springs 31b extending from the front side Df toward the back side Db.

The spring plate member 30A includes two parts; that is, a part including one band-like spring attachment portion 32a located on the back side Db and the opening-side arm springs 31a extending from the one band-like spring attachment portion 32a toward the front side Df, and a part including the other band-like spring attachment portion 32a located on the front side Df and the coupling-side arm springs 31b extending from the other band-like spring attachment portion 32a toward the back side Db. The spring plate member 30A has substantially the same effects as those of the above-described spring plate member 30. The spring plate member 30A includes a larger number of parts, but each of the parts may be smaller.

In the above-described spring plate member 30, the opening-side arm springs 31a extend from the spring attachment portion 32 on the back side Db toward the front side Df, whereas the coupling-side arm springs 31b extend from the spring attachment portion 32 on the front side Df toward the back side Db. That is, in the spring plate member 30, the opening-side arm springs 31a and the coupling-side arm springs 31b extend in the opposite directions to each other.

By contrast, as shown in FIG. 15(c), a spring plate member 30B may be configured such that the opening-side arm springs 31a and the coupling-side arm springs 31b both extend from the back side Db toward the front side Df. In this case, a support portion 35 supporting the coupling-side arm springs 31b is provided at, or in the vicinity of, a center of the spring attachment portion 32 in the dept direction D, and the coupling-side arm springs 31b extend from the support portion 35 toward the front side Df.

The spring plate member 30B may have substantially the same effect as those of the above-described spring plate member 30. In addition, the arm springs 31 (31a, 31b) located in two rows protrude in the width direction W when forming them from the back side Db toward the front side Df in the depth direction D. Therefore, the arm springs 31 are inclined in the depth direction D. Thus, the number of the contact points may be increased without the insertion of the male terminal 11 into the insertion space S being disturbed.

The spring plate member 30B may be modified to a spring plate member 30C having a two-part structure as shown in FIG. 15(d) in the same manner as that in which the spring plate member is modified to the spring plate member 30A. In this case, the band-like spring attachment portion 32a is located on the back side Db with respect to the coupling-side arm springs 31b. The spring plate member 30C may have substantially the same effects as those of the above-described spring plate member 30, and also may have substantially the same effects as those of the spring plate member 30A and the spring plate member 30B described above.

Now, with reference to FIG. 15(e) through FIG. 15(h), spring plate members 30D through 30G in other embodiments will be described.

The spring plate members 30 and 30A through 30C are configured to have two parts or configured such that the opening-side arm springs 31a and the coupling-side arm springs 31b extend in different directions from each other. In either case, the opening-side arm springs 31a and the coupling-side arm springs 31b having the contact points 34 provided at predetermined positions are shifted from each other in the height direction H, so that the opening-side contact points 34a on the opening-side arm springs 31a and the coupling-side contact points 34b on the coupling-side arm springs 31b are shifted from each other in the height direction H, that is, so that the opening-side contact points 34a on the opening-side arm springs 31a and the coupling-side contact points 34b on the coupling-side arm springs 31b are located at different positions in the height direction H.

By contrast, in each of the spring plate members 30D through 30G shown in FIG. 15(e) through FIG. 15(h), the opening-side arm springs 31a and the coupling-side arm springs 31b are not positionally shifted from each other, that is, the opening-side arm springs 31a and the coupling-side arm springs 31b are aligned in the depth direction D.

The opening-side contact points 34a on the opening-side arm springs 31a and the coupling-side contact points 34b on the coupling-side arm springs 31b are positionally shifted from each other. Specifically, in each of the spring plate members 30D through 30G, the opening-side contact points 34a on the opening-side arm springs 31a are located toward one side in the height direction H (leftward in FIG. 15) with respect to the contact points 34 on the arm springs 31 in the spring plate members 30 and 30A through 30C shown in FIG. 15(a) through FIG. 15(d) by approximately half of the length in the height direction H of each of the contact points 34.

By contrast, in each of the spring plate members 30D through 30G, the coupling-side contact points 34b on the coupling-side arm springs 31b are located toward the other side in the height direction H (rightward in FIG. 15) with respect to the contact points 34 on the arm springs 31 in the spring plate members 30 and 30A through 300 by approximately half of the length in the height direction H of each of the contact points 34.

In this manner, the opening-side contact points 34a on the opening-side arm springs 31a and the coupling-side contact points 34b on the coupling-side arm springs 31b are positionally shifted from each other in the height direction H. As a result, in each of the spring plate members 30D through 30G, even if the opening-side arm springs 31a and the coupling-side arm springs 31b positionally match each other in the height direction H, the opening-side contact points 34a on the opening-side arm springs 31a and the coupling-side contact points 34b on the coupling-side arm springs 31b may be positionally shifted from each other in the height direction H. That is, the opening-side contact points 34a on the opening-side arm springs 31a and the coupling-side contact points 34b on the coupling-side arm springs 31b may be located at different positions from each other in the height direction H.

Therefore, the spring plate members 30D through 30G may have substantially the same effects as those of the spring plate members 30 and 30A through 30C described above. In addition, the contact points 34a provided on the plurality of arm springs 31 lined up along the depth direction D are shifted from each other in the height direction H. Therefore, the contact points 34 (34a, 34b) on the plurality of arm springs 31 (31a, 31b) lined up along the depth direction D may be shifted in the height direction H with certainty.

The spring plate members 30D through 30G having the above-described effects may respectively have substantially the same effects as those of the spring plate members 30 and 30A through 30C.

Now, with reference to FIG. 15(i) through FIG. 15(l), spring plate members 30H through 30K in other embodiments will be described.

As described above, in the spring plate members 30 and 30A through 30C, the opening-side arm springs 31a and the coupling-side springs 31b having the contact positions 34 provided at predetermined positions are shifted from each other in the height direction H, so that the opening-side contact points 34a on the opening-side arm springs 31a and the coupling-side contact points 34b on the coupling side arm springs 31b are shifted from each other in the height direction H. In each of the spring plate members 30 and 30A through 30C, the opening-side arm springs 31a and the coupling-side arm springs 31b are provided in the same number (five).

By contrast, in each of the spring plate members 30H through 30K shown in FIG. 15(i) through 15(l), the positions of the contact points 34 with respect to the arm springs 31 are the same as each other, and the number of the opening-side arm springs 31a and the number of the coupling-side arm springs 31b are different from each other.

This will be described in more detail. In each of the spring plate members 30H through 30K, the opening-side arm springs 31a are provided in the number of five like the opening-side arm springs 31a in each of the spring plate members 30 and 30A through 30C, whereas the coupling-side arm springs 31b are provided in the number of four, which is smaller than the number of the opening-side arm springs 31a by one.

The coupling-side arm springs 31b provided in the number that is smaller than the number of the opening-side arm springs 31a by one are located at positions corresponding to positions between the five opening-side arm springs 31a arranged in the height direction H.

As a result, the opening-side arm springs 31a and the coupling-side arm springs 31b are shifted from each other in the height direction H; that is, the opening-side arm springs 31a and the coupling-side arm springs 31b are located at different positions from each other in the height direction H. Therefore, the opening-side contact points 34a on the opening-side arm springs 31a and the coupling-side contact points 34b on the coupling-side arm springs 31b are shifted from each other in the height direction H; that is the opening-side contact points 34a on the opening-side arm springs 31a and the coupling-side contact points 34b on the coupling-side arm springs 31b are located at different positions from each other in the height direction H.

Therefore, the spring plate members 30H through 30K may have substantially the same effects as those of the spring plate members 30 and 30A through 30C.

The spring plate members 30H through 30K having the above-described effects may respectively have substantially the same effects as those of the spring plate members 30 and 30A through 30C.

In the above description, the number of the coupling-side arm springs 31b are set to be smaller than the number of the opening-side arm springs 31a. Alternatively, the number of the coupling-side arm springs 31b may be set to be larger than the number of the opening-side arm springs 31a. The difference between the number of the opening-side arm springs 31a and the number of the coupling-side arm springs 31b is not limited to one, and may be any appropriate number.

The electric wire according to the present invention corresponds to the high-voltage electric wire 201 in the embodiments; and similarly,
the terminal main body corresponds to the terminal main body 201;
the spring member corresponds to the spring plate member 30;
the male terminal corresponds to the male terminal 11;
the insertion space corresponds to the insertion space S;
the side wall corresponds to the side wall 213;
the arm spring corresponds to the arm spring 31:
the insertion direction corresponds to the depth direction D;
the facing direction corresponds to the width direction W;
the perpendicular direction corresponds to the height direction H;
the contact point corresponds to the contact point 34;
the female terminal corresponds to the female terminal 21;
the base side corresponds to the front side Df;
the tip side corresponds to the back side Db;
the connector housing corresponds to the housing shell 23;
the connector corresponds to the harness-side connector 20;
the terminal-attached electric wire corresponds to the terminal-attached harness 204;
the connector-attached electric wire corresponds to the connector-attached electric wire 20a;
the wire harness corresponds to the wire harness 200; and
the coupling base portion corresponds to the bottom coupling portion 214.

However, the present invention is not limited to having any of the configurations of the above-described embodiments, and may be applied based on the technological idea defined by the claims and may be carried out in many embodiments.

For example, in the above description, the spring plate members 30 and 30A through 30K are each attached to each of two inner surfaces of the side walls 213 facing each other in the width direction W. Alternatively, the spring plate members 30 and 30A through 30K may each be provided on the inner surface of one side wall 213. In this case, the state of attachment is managed by use of the contact points 34, specifically, by the distance between the inner surface of the side wall 213 without any of the spring plate members 30 and 30A through 30K and the contact points 34 (34a, 34b).

In the above description, the contact points 34 (34a, 34b) on the arm springs 31 (31a, 31b) of any of the spring plate members 30 and 30A through 30K provided on both of the two inner surfaces of the side walls 213 facing each other in the width direction W are not shifted from each other in the height direction H, and face each other in the width direction W. Alternatively, the contact points 34 (34a, 34b) on the arm springs 31 (31a, 31b) may be shifted from each other in the height direction H.

In the above-described spring plate members 30 and 30A through 30C, the arm springs 31 having the contact points 34 provided at predetermined positions are positionally shifted from each other in the height direction H, and thus the opening-side contact points 34a on the opening-side arm springs 31a and the coupling-side contact points 34b on the coupling-side arm springs 31b are positionally shifted from each other in the height direction H. In the above-described spring plate members 30D through 30G, the opening-side arm springs 31a and the coupling-side arm springs 31b are not positionally shifted from each other in the height direction H, and the contact points 34 with respect to the arm springs 31 are positionally shifted from each other in the height direction H, so that the opening-side contact points 34a on the opening-side arm springs 31a and the coupling-side contact points 34b on the coupling-side arm springs 31b are positionally shifted from each other in the height direction H.

By contrast, the opening-side contact points 34a on the opening-side arm springs 31a and the coupling-side contact points 34b on the coupling-side arm springs 31b may be located as being positionally shifted from each other in the height direction H, and furthermore, the opening-side arm springs 31a and the coupling-side arm springs 31b may be positionally shifted from each other in the height direction H.

Even in this case, substantially the same effects as those of the above-described spring plate member 30 may be provided. In addition, the plurality of arm springs 31 (31a, 31b) lined up along the depth direction D and the contact points 34 (34a, 34b) provided on the arm springs 31 (31a, 31b) are shifted from each other in the height direction H. Therefore, the contact points 34 (34a, 34b) on the plurality of arm springs 31 (31a, 31b) lined up along the depth direction D may be shifted from each other in the height direction H with certainty.

The number of the contact points 34 on the arm springs 31 is not limited to the above-described number, and may be any appropriate number.

The above-described spring plate members 30 and the like are each secured to the inner surface of the side wall 213 by the welding portion 33. The method for securing is not limited to the above-described method, and may be any appropriate method.

In the above-described connector connection structure 1, the columns 148 of the extending bodies 147 are thicker than the plate-like connection portions 111. Alternatively, the thickness of the columns 148 may be approximately the same as that of the plate-like connection portions 111.

### REFERENCE SIGNS LIST

11 . . . male terminal
20 . . . harness-side connector
20a . . . connector-attached electric wire
21 . . . female terminal
23 . . . housing shell
31 . . . arm spring
30 . . . spring plate member
34 . . . contact point
200 . . . wire harness
201 . . . high-voltage electric wire
204 . . . terminal-attached harness
210 . . . terminal main body
213 . . . side wall
D . . . depth direction
Db . . . back side
Df . . . front side
H . . . height direction
S . . . insertion space
W . . . width direction

1. A female terminal, comprising:
a terminal main body connected to an electric wire and a spring member attached to the terminal main body,
wherein the terminal main body includes a pair of side walls located apart from each other by a predetermined distance and forming an insertion space into which a male terminal is insertable,
the spring member includes a plurality of arm springs contacting the male terminal inserted into the insertion space,
the arm springs are arranged to extend in parallel with an insertion direction, in which the male terminal is inserted into the insertion space, and a plurality of the arm springs are lined up along the insertion direction and a plurality of the arm springs are lined up along a perpendicular direction that is perpendicular to a facing direction, in which the side walls face each other, and also perpendicular to the insertion direction,
the arm springs are each provided with a contact point protruding so as to contact the male terminal, and
the contact points on the plurality of arm springs that are lined up along the insertion direction are shifted from each other in the perpendicular direction.

2. The female terminal according to claim 1, wherein the contact points provided on the plurality of arm springs that are lined up along the insertion direction are shifted from each other in the perpendicular direction.

3. The female terminal according to claim 1, wherein the plurality of arm springs that are lined up along the insertion direction are shifted from each other in the perpendicular direction.

4. The female terminal according to claim 1, wherein the plurality of arm springs lined up along the insertion direction are shifted from each other in the perpendicular direction, and the contact points provided on the arm springs are shifted from each other in the perpendicular direction.

5. The female terminal according to claim 1, wherein:
the arm springs are located in two rows lined up along the insertion direction,
one of the two rows of the arm springs protrudes in the facing direction when following it from a base side toward a tip side in the insertion direction, and
the other of the two rows of the arm springs protrudes in the facing direction when following it from the tip side toward the base side in the insertion direction.

6. The female terminal according to claim 1, wherein:
the arm springs are located in two rows lined up along the insertion direction, and
the two rows of the arm springs protrude in the facing direction when following them from a base side toward a tip side in the insertion direction.

7. A connector, comprising:
the female terminal according to claim 1; and
a connector housing accommodating the female terminal.

8. A terminal-attached electric wire, comprising:
the female terminal according to claim 1; and
the electric wire connected to the terminal main body of the female terminal.

9. A connector-attached electric wire, comprising:
the terminal-attached electric wire according to claim 8; and
a connector housing accommodating the terminal-attached electric wire.

10. A wire harness, comprising:
the terminal-attached electric wire according to claim 8.

11. A wire harness, comprising:
the connector-attached electric wire according to claim 9.
